(19) United States
(12) Patent Application Publication
(10) Pub. No.: US 2007/0286796 A1
(43) Pub. Date: Dec. 13, 2007

(54) SYNTHESIS OF HIGH SURFACE AREA NANOCRYSTALLINE MATERIALS USEFUL IN BATTERY APPLICATIONS

(75) Inventors: Olga Koper, Manhattan, KS (US); Janis Voo, Manhattan, KS (US); Slawomir Winecki, Manhattan, KS (US); John Rasinski, Akron, OH (US); Paul S. Malchesky, Painsville Twp., OH (US); Kenneth Klabunde, Manhattan, KS (US)

Correspondence Address: HOVEY WILLIAMS LLP, 2405 GRAND BLVD., SUITE 400, KANSAS CITY, MO, 64108, US

(73) Assignee: NANOSCALE CORPORATION, Manhattan, KS (US)

(21) Appl. No.: 11/759,106

(22) Filed: Jun. 6, 2007

Related U.S. Application Data
(60) Provisional application No. 60/804,049, filed on Jun. 6, 2006.

(51) Int. Cl. C01G 23/04; C01G 31/02

(52) U.S. Cl. 423/598; 423/593.1; 423/594.8

(57) ABSTRACT

An improved mixed metal oxide material suitable for use in electrochemical cells is provided. The mixed metal oxide material generally exhibits high surface area and pore volume than conventionally manufactured materials thereby imparting improved electrochemical performance. Batteries manufactured using the mixed metal oxide material are particularly suited for use in implantable medical devices.

### RELATED APPLICATION

The present application claims the benefit of U.S. Provisional Patent Application Ser. No. 60/804,049, filed Jun. 6, 2006, which is incorporated by reference herein.

### BACKGROUND OF THE INVENTION

1. Field of the Invention

The present invention generally pertains to nanocrystalline materials, their synthesis, and usage in energy storage devices such as batteries. More particularly, the present invention is directed toward mixed metal oxide materials having small crystallite sizes, and relatively high surface areas and pore volumes that may be used in the manufacture of battery electrodes.

2. Description of the Prior Art

Silver vanadium oxide (SVO) is a common cathode material for use in batteries, especially lithium batteries. Traditionally synthesized SVO exhibits certain characteristics which may limit its performance in an electrochemical cell. For example, traditional methods of producing SVO, such as those disclosed in EP 1388905, call for reducing the particle size of the SVO in order to improve discharge efficiency by using mechanical means, such as a mortar and pestle, a ball mill, or a jet mill. However, such mechanical grinding means have little to no positive effect on the other properties of the SVO that may affect discharge efficiency such as pore diameter and pore volume.

Thus, a need exists in the art for an improved material having enhanced physical properties such as increased surface area and increased pore volume that will improve the electrochemical capacity of the material thereby making it a much more effective for use in electrochemical cells.

### SUMMARY OF THE INVENTION

In one embodiment of the present invention, there is provided a nanocrystalline mixed metal oxide material that presents a surface area of about 1.5 to about 300 m²/g.

In another embodiment of the present invention, there is provided a nanocrystalline mixed metal oxide comprising at least a first metal component M₁, a second metal component M₂, and oxygen, and having the general formula (M₁)ₓ(M₂)_{y}(O)_{z} wherein: M₁ is selected from the group consisting of the transition metals, the alkali metals, and the alkaline earth metals; M₂ is different from M₁ and is selected from the group consisting of the transition metals; and the sum of x, y, and z is 1. The mixed metal oxide presents a surface area of about 1.5 to about 300 m²/g.

In yet another embodiment of the present invention, there is provided a process for synthesizing a nanocrystalline metal oxide material. The process generally comprises the steps of (a) dispersing at least one metal-containing precursor material in a solvent; (b) aging the dispersion for a predetermined length of time thereby forming a gel; (c) removing at least a portion of the solvent from the gel thereby recovering a metal-containing residue; and (d) heat treating the residue.

In still another embodiment of the present invention, there is provided a battery comprises an electrode that contains a mixed metal oxide according to the present invention.

### BRIEF DESCRIPTION OF THE DRAWINGS

FIG. 1 is a schematic diagram of a battery comprising an electrode containing a mixed metal oxide in accordance with the present invention; and

FIG. 2 is an X-ray diffraction spectra overlay of several silver vanadium oxides.

### DETAILED DESCRIPTION OF THE PREFERRED EMBODIMENT

The mixed metal oxides according to the present invention can be synthesized by several methods. However, regardless of the method selected, the resulting nanocrystalline mixed metal oxide exhibits one or more, and in certain embodiments, all of the following characteristics: high surface area, large pore volume, and small pore diameter.

The mixed metal oxides prepared in accordance with the present invention generally exhibit a BET surface area of between about 1.5 to about 300 m²/g, more preferably between about 2 to about 100 m²/g, and most preferably between about 10 to about 75 m²/g. The mixed metal oxides also present average crystallite sizes of between about 2-100 nm, more preferably between about 3 to about 50 nm, and most preferably between about 4 to about 20 nm. Crystallite size is contrasted with the particle size (as the individual particles may comprise a plurality of crystals). Generally, the materials present average particle sizes of about 10 to about 20,000 nm, preferably between about 10 to about 1,000 nm, more preferably between about 20 to about 500 nm, and most preferably between about 30 to about 300 nm. In certain embodiments, the materials exhibit relatively large pore volumes ranging from about 0.001 to about 1 cc/g.

The mixed metal oxides may comprise a numerous combinations of metal species. Generally, the mixed metal oxides comprise two different metal species. However, it is within the scope of the present invention for the mixed metal oxide to comprise more than two metals. For example, the mixed metal oxide may comprise a plurality of metals, such as 3, 4, 5, or more metals. Thus, in certain embodiments, the mixed metal oxides will comprise at least first and second metals, with the first metal being selected from the transition, alkali or alkaline earth metals, with silver, lithium, and barium being particularly preferred. The second metal is selected from the transition metals (Groups 3-12 of the IUPAC Periodic Table), with vanadium, molybdenum, and titanium being particularly preferred. In certain embodiments, particularly those comprising lithium, the mixed metal oxide comprises elements with cubic or hexagonal elemental crystal structures possessing a nanocrystalline nature. Also, the transition metal is preferably one that undergoes an electron shift of 2 to 3 or 3 to 4 electrons. In those embodiments in which the first and second metals are transition metals, the first transition metal is different from the second transition metal.

In another embodiment, the nanocrystalline mixed metal oxide comprises at least a first metal component M₁, a second metal component M₂, and oxygen, and has the general formula
(M₁)ₓ(M₂)_{y}(O)_{z},
wherein

M₁ is selected from the group consisting of the transition metals, the alkali metals, and the alkaline earth metals;

M₂ is different from M₁ and is selected from the group consisting of the transition metals; and

the sum of x, y, and z is 1.

It is noted that it is an accepted practice to normalize the values for x, y, and z. Thus, x, y, and z may be expressed as fractional values whose sum is equal to 1. This practice takes into account metal atoms that may be shared by adjacent crystal structures. However, for purposes herein, the expression of x, y, and z as fractional values does not necessarily imply that the atoms are in fact shared among adjacent crystals. Thus, for any mixed metal oxide compound, the amount of each atom present could be expressed as a fractional values simply by normalizing the values for x, y, and z. For example, Ag₂V₄O₁₁ may be expressed as Ag_{0.12}V_{0.23}O_{0.65} (the number of each atom is divided by 17, the total number of atoms), LiMoO₂ as Li_{0.25}Mo_{0.25}O_{0.5} (the number of each atom divided by 4), and BaTiO₃ as Ba_{0.2}Ti_{0.2}O_{0.6} (the number of each atom divided by 5).

In certain embodiments, as an alternative to normalization, x is from about 0.01 to about 5, y is from about 0.01 to about 5, and z is from about 0.1 to about 11. Thus, in this embodiment, x, y, and z may be expressed in fractional values, integers, or combinations thereof.

Further, the mixed metal oxide may comprise additional metal components M₃, M₄ . . . Mₙ. The amount of the additional metal component may or may not be taken into consideration with the normalized values for M₁, M₂, and O. Therefore, the additional metal components may be present at any level, particularly at a level of from about 0.01 to about 5.

In certain preferred embodiments, M₁ is either silver, copper, lithium, or barium and M₂ is vanadium, molybdenum, or titanium.

Thus, particularly preferred mixed metal oxides in accordance with the present invention include, but are not limited to, sliver vanadium oxide (SVO or Ag₂V₄O₁₁), lithium molybdate (LiMoO₂), barium titanate (BaTiO₃), silver chromate (Ag₂CrO₄), lithium manganese dioxide (LiMnO₂), lithium manganese oxide (LiMn₂O₄), lithium nickel oxide (LiNiO₂), and lithium cobalt oxide (LiCoO₂).

The high surface area presented by the nanocrystalline mixed metal oxides make these materials particularly well suited for use in electrodes (and specifically, cathodes) of batteries. In the case of a lithium ion battery, the high surface area creates a short diffusion length for the lithium ions to more readily and easily inject and extract from the solid matrix of the material. Thus, the present mixed metal oxides allow for enhanced and more efficient use of the battery cathode material. Furthermore, the materials according to the present invention exhibit excellent electrochemical capacities. In certain embodiments, the electrochemical capacity of the mixed metal oxide is at least about 100 mAh/g, and in certain embodiments may be between about 100 to about 700 mAh/g, more preferably between about 100 to about 400 mAh/g, even more preferably between about 150 mAh/g to about 375 mAh/g, and most preferably between about 200 mAh/g to about 350 mAh/g.

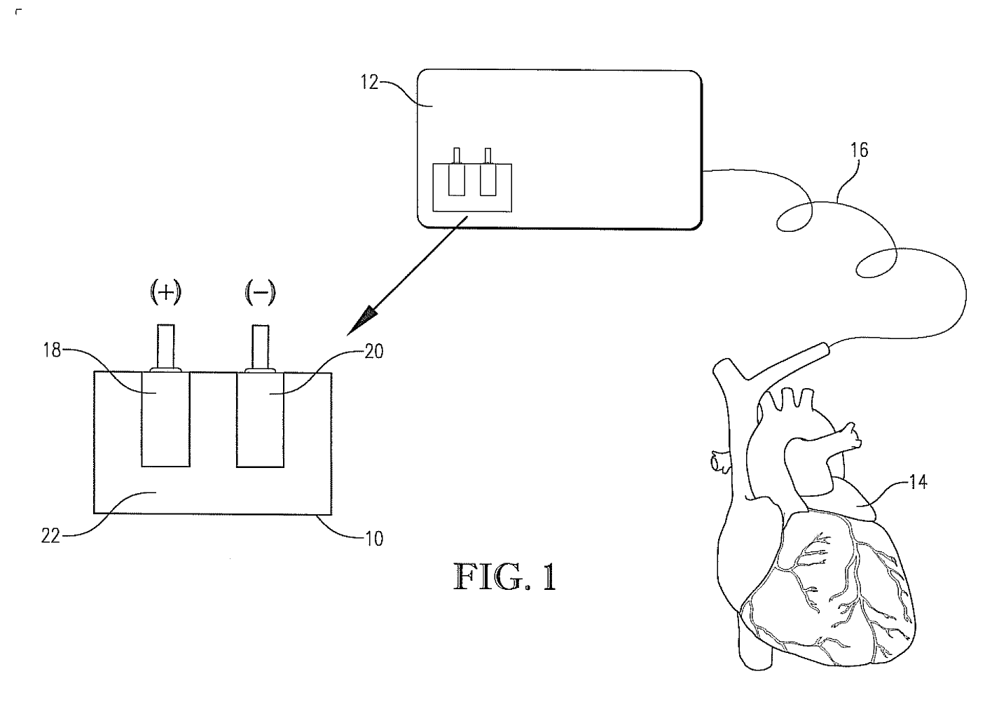

Therefore, in another embodiment of the present invention, a battery is provided comprising an electrode formed from or containing at least one mixed metal oxide as herein described. FIG. 1 generally depicts such a battery cell 10 for use with an implantable device 12 such as a pacemaker, cardiac defibrilator, drug pump, neurostimulator, or self-contained artificial heart. Device 12 may also be one that is external to the body. Device 12 (shown as a pacemaker) is connected to the individual's heart 14 through a wire 16. The battery's cathode 18 comprises the mixed metal oxide material according to the present invention. The anode 20 may be made from any conventional material known to be suitable for that purpose. Cathode 18 and anode 20 are suspended in an electrolyte solution 22. The electrodes comprising the mixed metal oxide may be coated with another material to improve performance or may be left uncoated.

Direct Sol-Gel Synthesis

The mixed metal oxides in accordance with the present invention may be synthesized via several methods. A first method of preparing the mixed metal oxide involves a direct sol-gel approach that is intended to introduce both metal ions (silver and vanadium in the case of SVO) into the solution prior to gelation in order to achieve a uniform and intimate mixture with the desired stoichiometry. The transition metal is generally provided in the form of a transition metal alkoxide. The silver, alkali metal or alkali earth metal is provided as a salt of the particular metal. The transition metal alkoxide and metal salt are dispersed in a solvent system. Preferred solvent systems include aqueous systems that also comprise a common organic solvent such as a ketone or an alcohol (e.g. acetone, isopropanol, and ethanol). One exemplary solvent system includes water and acetone. The molar ratio of the water and organic solvent may be readily varied. The addition of the precursor materials to the solvent system is generally performed under temperature conditions of about 0 to just below the boiling point of the solvents, or about 15° C. The solution is optionally stirred for a period of time, in certain embodiments for about 5 days, at ambient conditions. Subsequently, the mixture is aged for an additional length of time (minutes to days) as the gel forms, in certain embodiments about 7 days.

Next, the solvent is removed. The solvent removal step assists in preserving the high surface area and porosity of the mixed metal oxide. The sol-gel may be sensitive to particular drying methods and conditions employed. Thus, selection of the appropriate solvent removal step should take these considerations into account. The solvent may be removed from the sol-gel by any of the following means: ambient drying (i.e., ambient to about 40° C.) including flushing or static drying under oxygen, air or inert gas (nitrogen, argon, etc.); vacuum drying using a rotary evaporator (at about 20 to about 100° C.) or vacuum line; freeze-drying wherein the gel is cooled below the freezing temperature of the organic solvents and vacuum is applied to remove the solvent; supercritical drying using high temperature and pressure, generally about 40 to about 220° C. and about 590 to about 1200 psi (autoclave solvent removal around supercirtical conditions of the organic solvents, e.g., 220° C. and 590 psi for acetone); hypercritical drying; ambient temperature and high pressure drying using, for example CO₂ (CO₂ drying carried out at 40° C. and 1200 psi, substantially all of the water will need to be removed by solvent exchange in advance); and solvent exchange wherein the original organic solvent (e.g., acetone or isopropanol) is exchanged with a second solvent having a lower surface tension (e.g., cyclohexane or toluene) and then the second solvent is removed by the techniques described above.

Next, the dried product may undergo vacuum outgassing to remove residual solvent adsorbed on the product surface and contained within the product pores. However, this step can be eliminated if the appropriate heat treatment conditions (described below) are applied. For outgassing, the metal oxide precursorproduct is placed in a vacuum oven and continuous vacuum is applied (a rotary vane pump with an ultimate pressure of 10⁻³ Torr is sufficient). The product is then heated to a temperature of between about 100 to about 500° C. for a period of between about 0.1 to about 10 hours. However, in certain embodiments, the outgassing is carried out at about 250 to about 325° C. for about 1 to about 3 hours. After the heating period, the product is allowed to cool to room temperature, the oven is vented with air, and the sample is removed.

Finally, the powdered product may be heat treated to obtain the desired stoichiometry. Since the sol-gel contains amorphous or nanocrystalline species, the heat treatment conditions must be carefully selected to preserve the specific surface areas and porosities while producing the desired stoichiometry. The sample is placed in an oven operating under atmospheric air. The sample is spread uniformly in a suitable container and forms a thin bed in order to minimize mass transfer limitations. The sample is then heated to between about 100 to about 1000° C. for a period of about 30 minutes to about 50 hours. The temperature program may comprise a single step (one fixed temperature applied for a specific period of time) or include multiple steps (varying temperature with time). After the heat treatment, the sample is allowed to cool down to room temperature and removed from the oven. One or more grinding steps may be applied prior, during, or after the heat treatment.

It is noted that the activation technique (air or oxygen flow) and the type of solvent used in the synthesis may have an influence on the properties of the heat treated material and the final quality of the mixed metal oxide.

Further lithium transition metal oxides may be synthesized through an aerogel process generally described by Klabunde et al., J. Phys. Chem., 1996, 100, 12142; and S. Utamapanya et al., Chem. Mater., 1991, 3, 175, each of which are incorporated by reference herein.

Synthesis of High Surface Area Transition Metal Oxide with a Subsequent Addition of Silver, Alkali Metal or Alkaline Earth Metal Precursors

This next approach required the synthesis of a high surface area transition metal oxide in a powder form, which is used as a precursor in a follow-on synthesis of the mixed metal oxide. The synthesis of the transition metal oxide gel is carried out using the transition metal alkoxide as a precursor. Hydrolysis of the alkoxide is conducted in a solvent system at a temperature of between about 0 to about 15° C., under a nitrogen atmosphere. Preferred solvent systems include acetone, acetone/cyclohexane, acetone/toluene, methanol/toluene, and/or isopropanol using various ratios of water (2-40 fold excess). In certain embodiments, the ratio of the transition metal alkoxide, water and organic solvent is about 1:40:20. The gel, upon formation, is aged for between 1 to 14 days, preferably for at least a minimum of 7 days.

Next, the solvent system is removed from the transition metal oxide gel. The desolvation of the transition metal oxide gel may be performed using one of the following methods: ambient drying including flushing or static drying under oxygen, air or inert gas (nitrogen, argon, etc.); vacuum drying using a rotary evaporator or vacuum line; freeze drying which includes cooling the gel below the freezing temperature of the organic solvents and applying vacuum to remove the solvent; supercritical drying being conducted at around supercritical conditions for the organic solvents (e.g., in an autoclave at 220° C. and 590 psi for acetone); or at ambient temperature and high pressure (CO₂ drying, at 40° C. and 1200 psi, with removal of all water by repeated solvent exchange prior to CO₂ supercritical drying); and solvent exchange wherein the original organic solvent, such as acetone or isopropanol, is ex-changed with a second solvent (e.g., liquid carbon dioxide, diethyl ether, ethanol, cyclohexane, etc.) which is subsequently removed by one of techniques described above.

After the solvent removal step, the dried product undergoes a heat treatment step to convert the transition metal oxide sol-gel to the desired transition metal oxide. This step is carried out either under a flow of air or oxygen under conditions similar to the heat treatment step described for the direct sol-gel approach. In certain embodiments, this particular heat treatment step is performed at 300° C. for 24 hours.

Finally, a silver, alkali metal, or alkaline earth metal salt precursor is mixed with the transition metal oxide and the mixture is heat treated at anywhere from room temperature up to about 350° C., as desired.

Synthesis of High Surface Area Metal with a Subsequent Addition of Metal Oxide

This method begins by synthesizing a high surface area metal that will subsequently be combined with a metal oxide. Thus, in certain embodiments, this step involves the formation of a high surface area metal selected from the group consisting of silver, alkali metals, and alkaline earth metals. The high surface area metal may be produced through a solvated metal tom dispersion (SMAD) process as described in Franklin et al., High Energy Process in Organometallic Chemistry; Suslick, K. S., Ed.; ACS Symposium Series; American Chemical Society: Washington, D.C. 1987; PP246-259; and Trivino et al., Langmuir 1987, 3, 986-992.

The nanocrystalline, high surface area metal can be synthesized using the solvated SMAD method with toluene or acetone as solvents. In the SMAD synthesis, the metal is evaporated under vacuum using a resistively heated evaporation boat. Metal vapor is then codeposited together with vapors of organic solvent on externally cooled walls of the vacuum chamber. Typically, liquid nitrogen at its boiling point (77 K) is used as a chamber cooling medium. The vacuum chamber is dynamically evacuated by a suitable vacuum pump and a total pressure of non-condensable gases is 10⁻³ Torr, or less. The codeposition reaction produces a uniform matrix of metal atoms and small metal clusters trapped and immobilized in a frozen solvent. After completion of the codeposition process the metal-solvent matrix is allowed to melt which triggers rapid formation of nanosized metal particles. These particles are separated from the solvent by means of decanting, filtering, or solvent evaporation. Collected dry product typically has a form of agglomerated nanocrystals intimately mixed with organic groups introduced by the solvent.

Next, the nanocrystalline metal is mixed with a metal oxide in the desired proportion. In the case of silver and vanadium oxide, this proportion is one mole of silver per two moles of vanadium. The mixture is dispersed in water with possible addition of an alkali metal base (e.g., NaOH) to form a thick paste that is stirred for several hours ensuring uniform dispersion of the metal and metal oxide. The paste is then dried in air and ground in preparation for a final heat treatment step, which is conducted in a manner such as those heat treatment steps described above.

One or more of the following are features which may affect the materials produced according to an embodiment of the present invention: selection of raw materials (precursors), mixing of precursors, solvent ratios, temperature, aging period, dehydration method, and heat treatment process.

### EXAMPLES

The following examples set forth SVO formulations made in accordance with the present invention. It is to be understood, however, that these examples are provided by way of illustration and nothing therein should be taken as a limitation upon the overall scope of the invention.

### Example 1

### SVO Prepared by Direct Sol-Gel Approach

Sol-gels were prepared under the following conditions: 8 ml of vanadium triisopropoxy oxide (VIP) was chilled to 0° C. and added to an Erlenmeyer flask under N₂, Ar, and He. If needed, the synthesis of the VIP precursor can be carried out as follows:
V₂O₅+i-C₃H₇OH→VO(OC₃H₇)₃+H₂O equation (1)
or
VOCl₃+i-C₃H₇OH→VO(OC₃H₇)₃+HCl equation (2)
2.887 g of AgNO₃ were dissolved in 25 ml of water and 50 ml of acetone was then added to the solution. (Note, silver lactate or silver nitrite could be used in place of the silver nitrate. However, silver nitrate was chosen due to its high solubility in water.) This mixture was also cooled to 0° C. and then added to the VIP. Generally, the molar ratio of the VIP, silver nitrate, water, and acetone is 2:1:80:40. During addition both a brown precipitate and a small amount of brown gel formed. The gel was broken up by mechanical mixing and the flask was wrapped in aluminum foil and mixed continuously for 3-5 days. Then the gel was left undisturbed at room temperature. Upon aging at least 5 days a brown gel formed. Various methods were used for solvent removal, vacuum outgassing, and heat treatment, as detailed below. The general reaction scheme for formation of the SVO is described by the equation:
4VO(OC₃H₇)₃+2AgNO₃+3H₂O→Ag₂V₄O₁₁+12C₃H₇OH+2NOₓ

Sample A

After aging for 18 days, the SVO was placed in an autoclave and the solvent removed. 280 ml of acetone were added to the sol-gel prior to drying. The autoclave was heated from room temperature to 220° C. during a 0.5 hour period. The final temperature of 220° C. was maintained for 5 min. The final pressure was 600 psi. After release of acetone vapor, a nitrogen purge was applied, the nitrogen flow was ˜0.5 L/min.

The sample was outgassed/activated under vacuum at 325° C. overnight (11-13 hours). Final activation was carried out under air at 325° C. for 16 hours.

Sample B

After aging for 10 days, the SVO sample was placed in a Schlenk tube. At ambient temperature, removal of solvents under reduced pressure (approximately 10⁻¹ Torr) yielded a brown solid. Then the sample was outgassed under dynamic vacuum at 325° C. for 1 hour and heat treated in air at 325° C. for 16 hours.

Sample C

After aging for 11 days, the SVO sample was dried in an autoclave. The removal of the solvents, water and acetone, was performed at 220° C. and 590 psi. After solvent removal, the sample was heat treated in air using the following temperature program: heating to 90° C. over 5 hours, linear increase of temperature from 90° C. to 300° C. during 16 hours followed by heating at 300° C. for an additional 16 hours.

Sample D

After aging for 8 days, the sol gel was washed with a 2 to 5 times excess of diethyl ether over a two-week period. After several washings, the SVO sample was dried using a supercritical CO₂ dryer. The sample was outgassed under dynamic vacuum at 325° C. for 1 hour, and then treated in air at 325° C. for 16 hours.

Sample E

Sample E was a combination of three batches of individually prepared SVO. Prior to mixing of all three SVO batches to yield Sample E, each SVO batch was separately prepared and dried as follows: After aging for 20 days, all three SVO samples were dried using an autoclave. The removal of the solvents, water and acetone, was performed at 220° C. and 590 psi. Then, each batch was outgassed differently under continuous vacuum ranging from 150-325° C. for 1-17 hours. Eventually, the individual sample was heat treated in air ranging from 250-325° C. for 16 hours.

Sample F

Sample F was a combination of several batches of individually prepared SVO. Prior to mixing of individual SVO batches to yield Sample F, each SVO batch was separately prepared and dried as follows: After aging for at least 10 days, the solvent was removed by rotary evaporation at 20° C. under reduced pressure (approximately 10⁻¹ Torr) yielding a brown solid. The sample was outgassed under dynamic vacuum at 325° C. for 1 hour and then heat treated in air at 300° C. for 16 hours.

Sample G

After aging for 12 days, the sol-gel was washed with a 2 to 5 times excess of diethyl ether several times over a two-week period. Remaining ether was decanted and the sample dried under ambient conditions. Further drying was performed using supercritical CO₂. The sample was outgassed under dynamic vacuum at 325° C. for 1 hour, and then heat treated in air at 300° C. for 16 hours.

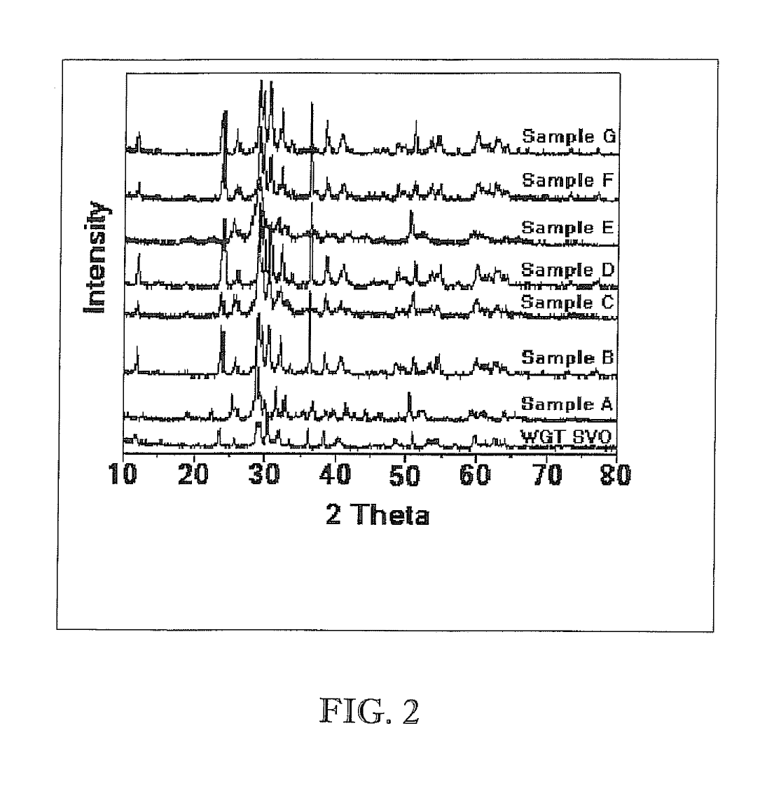

Table 1 outlines the physical properties of WGT SVO and Sample A through Sample G prepared in accordance with the present invention. X-ray diffraction (XRD) spectra of Sample A through Sample G and WGT SVO are shown in FIG. 2. Sample A is an unidentified form of SVO, resembling oxygen deficient Ag₂V₄O_{11-y}. Samples B-G exhibit very similar XRD patterns compared to WGT Ag₂V₄O₁₁.

TABLE 1

| | Identification of the | Surface Area | Pore Volume | DSC (° C.) Endothermic | Tap Density | SEM (nm) |
|---|---|---|---|---|---|---|
| | material by powder XRD | (m²/g) | (cc/g) | Peaks (° C.) | (g/cc) | Covered Range |
| WGT SVO | Ag₂V₄O₁₁ | 0.4-0.7 | 1.9 × 10⁻³ | 546, 558 | 1.64 | 900 (APS) |
| | | | | | | 170-2100 |
| Sample A | Ag₂V₄O_{11-y} | 3.7 | 25 × 10⁻³ | 553 | 0.59 | 120 (APS) |
| | | | | | | 50-300 |
| Sample B | Ag₂V₄O₁₁ | 4 | 14 × 10⁻³ | 526, 575 | 1.56 | 300 (APS) |
| | | | | | | 90-830 |
| Sample C | Ag₂V₄O₁₁ | 10 | 41 × 10⁻³ | 471, 526, 575 | 0.43 | 120 (APS) |
| | | | | | | 30-420 |
| Sample D | Ag₂V₄O₁₁ | 4.8 | 13 × 10⁻³ | 540, 564 | N/A | N/A |
| Sample E | Ag₂V₄O₁₁ | 52 | N/A | N/A | N/A | N/A |
| Sample F | Ag₂V₄O₁₁ | 5.6 | 19 × 10⁻³ | 535, 565 | N/A | N/A |
| Sample G | Ag₂V₄O₁₁ | 6.3 | 24 × 10⁻³ | 468, 544, 564 | N/A | N/A |

WGT SVO—Silver Vanadium Oxide obtained from Wilson Greatbatch Technologies; APS—Average particle size; DSC—Differential scanning calorimetry; N/A—Not available

Table 2 provides data regarding the electrochemical capacity of SVO samples made in accordance with the present invention.

TABLE 2

| | Capacity (mAh/g) | | |
|---|---|---|---|
| Sample | Trial 1 | Trial 2 | Average |
| SVO (Sample A) | 259.14 | 248.66 | 253.9 |
| SVO (Sample B) | 280.99 | 281.14 | 281.1 |
| SVO (Sample C) | 256.00 | 252.77 | 254.4 |

### Example 2

### Examples of SVO Prepared by Synthesis of Vanadium Pentoxide with the Subsequent Addition of Silver Salt Precursors

Sample H

(i) Under a nitrogen atmosphere, 8 ml of vanadium triisopropoxy oxide (VIP) was charged into a 125 ml Erlenmeyer flask cooled to 0° C. A mixture of water/acetone (25 ml:50 ml) cooled at 0° C. was added to the vanadium precursor. Upon addition, a deep red-orange gel produced. The gel was aged 22 days in the dark to yield a green color gel. The general reaction scheme may be described by the following equation:
2VO(OC₃H₇)₃+3H₂O→V₂O₅+6C₃H₇OH

(ii) 2.887 g AgNO₃ was dissolved in a mixture of water and acetone (7 ml: 130 ml). This solution was added to the green gel. The flask was wrapped with aluminum foil and was stirred for 3 days. A brown gel was produced upon aging for 39 days.

(iii) After aging, desolvation step was performed on the brown gel. The gel was dried using an autoclave at 220° C. and 590 psi, to which a blue-black solid was isolated.

Sample I

(i) Under a nitrogen atmosphere, 3.25 ml vanadium triisopropoxy oxide was charged into a 125 ml Erlenmeyer flask cooled to 0° C. To this, a mixture of water and ethanol (0.3 ml:5 ml) was added causing gel formation.

(ii) 1.3596 g silver lactate was dissolved in a mixture of water and ethanol (9.6 ml:5 ml) and added to the Erlenmeyer flask. The gel was left to age in the dark for 14 days.

(iii) After aging, solvent exchange was performed using diethyl ether. This was followed by CO₂ supercritical drying at 35° C. and 1200 psi to yield a green solid.

(iv) The powder was vacuum outgassed at 325° C., 1 hour. The SVO was then heat treated under air at 325° C., 16 hour.

Sample J

(i) Premixed 1.44 g AgNO₃ and 4 ml vanadium triisopropoxy oxide (VIP) in 75 ml ethanol and cooled the mixture to 0° C.

(ii) Then, a water-acetone (12 ml:25 ml) solution was added to the Ag—V premix causing gel formation. The orange colored gel was aged for 14 days.

(iii) After aging, the gel was dried using an autoclave at 220° C. and 590 psi.

Sample K

(i) Under a nitrogen atmosphere, a 125 ml Erlenmeyer flask was charged with 8 ml of vanadium triisopropoxy oxide (VIP) at 0° C. A water-acetone (25 ml:50 ml) mixture was added to VIP initiating hydrolysis and gelation. The gel was aged 22 days.

(ii) 2.887 g AgNO₃ was dissolved in 1 ml hot water and added dropwise to the gel. The mixture was stirred for 3 days and was aged for 38 days.

(iii) Solvent was removed under vacuum at ambient temperature.

(iv) The brown solid was grounded followed by vacuum outgassing at 300° C. for 1 hr.

(v) Thereafter, the brown solid was further microwave treated at 325° C. for 16 hrs.

Sample L

The nanocrystalline silver was prepared by the SMAD method using silver metal and toluene. A total of 70 ml of solvent was used per each gram of metallic silver. The nanocrystalline product was separated-rated from excess toluene by decanting and evaporation. Thereafter, 0.86 g of dry nanocrystalline silver and 2.24 grams of WGT V₂O₅ were dispersed in 8 ml of distilled water. The slurry was stirred for 5 hours and heated to 40-70° C. and then dried by heating to 110° C. in an open container for a period of 2 hours. The final heat treatment step included heating of the sample to 350° C. in air for 5 hours. The resulting product was a mixture of the desired Ag₂V₄O₁₁ and AgV₇O₁₈ impurity with an overall specific surface area of 1.1 m²/g.

Sample M

The synthesis of this SVO material differs from the previous example in the way the water slurry was prepared. Specifically, 0.75 g of nanocrystalline silver and 1.94 grams of WGT V₂O₅ were dispersed in 7.2 ml of 0.1% NaOH water solution. Drying of the slurry and the heat treatment steps were identical to the previous example. The resulting product had a specific surface area of 2.7 m²/g. and contained more impurities including Ag_{0.35}V₂O₅, AgV₇O₁₈ and V₂O₅.

### Example 3

### LiMoO₂ Preparation Using Direct Sol-Gel Method

The following describes an exemplary procedure for preparing LiMoO₂ using the direct sol-gel method described above. This synthesis involves the use of a lithium precursor, a molybdenum precursor, and an alcohol. The lithium precursor may be selected from the group consisting of: Li₂CO₃, Li₂O, LiOH, LiOR (wherein R is CH₃, C₂H₅, or C₃H₇), LiNO₃, LiO₂CCH₃, LiO₂CCH₂COCH₃, CH₃(LiO)C═CHCOCH₃, LiX (wherein X is F, Cl, Br, or I), LiClO₄, LiSO₃CF₃. The molybdenum precursor may be selected from the group consisting of MoCl₃, MoBr₃, and MoCl₅. The alcohol may be selected from the group consisting of methyl, ethyl or n-propyl alcohol.

The molybdenum precursor is initially converted into an alkoxide species followed by the addition of a lithium precursor. While stirring, an appropriate amount of water is added to hydrolyze the mixture. The mixing is carried out over a certain period of time. Once completed, the reaction solvent is removed using a heat treatment process (between about 100 to about 200° C.). The isolated solid is then calcined under an inert atmosphere (nitrogen, argon, or helium) at a predetermined temperature and time (between about 250 to about 900° C. for between about 24 to about 48 hours).

We claim:

1. A nanocrystalline mixed metal oxide material presenting a surface area of about 1.5 to about 300 m²/g.

2. The material according to claim 1, wherein said material has an average particle size of about 10 to about 20,000 nm.

3. The material according to claim 1, wherein said material presents an average crystallite size of about 2 to about 100 nm.

4. The material according to claim 1, wherein said material presents an average pore volume of about 0.001 to about 1 cc/g.

5. The material according to claim 1, wherein said material comprises a first metal selected from the alkali or alkaline earth metals.

6. The material according to claim 5, wherein said material comprises a second metal selected from the transition metals.

7. The material according to claim 6, wherein said first metal is lithium or barium.

8. The material according to claim 7, wherein said material comprises LiMoO₂.

9. The material according to claim 7, wherein said material comprises BaTiO₃.

10. The material according to claim 1, wherein said mixed metal oxide comprises a first transition metal and a second transition metal different from said first metal.

11. The material according to claim 10, wherein said first metal is silver

12. The material according to claim 11, wherein material comprises Ag₂V₄O₁₁.

13. The material according to claim 1, wherein said material presents an electrochemical capacity of at least about 100 mAh/g.

14. A nanocrystalline mixed metal oxide comprising at least a first metal component M₁, a second metal component M₂, and oxygen, and having the general formula (M₁)ₓ(M₂)_{y}(O)_{z} wherein:
M₁ is selected from the group consisting of transition metals, the alkali metals, and the alkaline earth metals;
M₂ is different from M₁ and is selected from the group consisting of the transition metals, and
the sum of x, y, and z is 1,
said mixed metal oxide presenting a surface area of about 1.5 to about 300 m²/g.

15. The mixed metal oxide according to claim 14, wherein said mixed metal oxide has an average particle size of about 10 to about 20,000 nm.

16. The mixed metal oxide according to claim 14, wherein said mixed metal oxide presents an average crystallite size of about 2-100 nm.

17. The mixed metal oxide according to claim 14, wherein said mixed metal oxide presents an average pore volume of about 0.001 to about 1 cc/g.

18. The mixed metal oxide according to claim 14, wherein M₁ is lithium.

19. The mixed metal oxide according to claim 14, wherein M₁ is silver.

20. The mixed metal oxide according to claim 14, wherein M₂ is selected from the group consisting of vanadium, molybdenum, and titanium.

21. The mixed metal oxide according to claim 14, wherein said mixed metal oxide is selected from the group consisting of Ag_{0.12}V_{0.23}O_{0.65} (Ag₂V₄O₁₁), Li_{0.25}Mo_{0.25}O_{0.5} (LiMoO₂), Ba_{0.2}Ti_{0.2}O_{0.6} (BaTiO₃), and combinations thereof.

22. The mixed metal oxide according to claim 14, wherein said mixed metal oxide presents an electrochemical capacity of at least about 100 mAh/g.

23. The mixed metal oxide according to claim 14, wherein said mixed metal oxide comprises at least one additional metal component.

24. A process for synthesizing a nanocrystalline metal oxide material comprising the steps of:
a) dispersing at least one metal-containing precursor material in a solvent;
b) aging said dispersion for a predetermined length of time thereby forming a gel;
c) removing at least a portion of said solvent from said gel thereby recovering a metal-containing residue; and
d) heat treating said residue.

25. The process according to claim 24, wherein step a) comprises dispersing a first metal-containing precursor material in a solvent and adding a second metal-containing precursor material thereto.

26. The process according to claim 25, wherein said first precursor material is selected from the group consisting of silver, lithium, and barium salts.

27. The process according to claim 26, wherein said second precursor material comprises a transition metal oxide or alkoxide.

28. The process according to claim 24, wherein step a) comprises dispersing a transition metal alkoxide in said solvent thereby forming a transition metal oxide that is dispersed in said solvent.

29. The process according to claim 28, further comprising:
e) mixing said transition metal oxide with a silver, lithium, or barium salt; and
f) heat treating said transition metal oxide and salt mixture to form said mixed metal oxide.

30. The process according to claim 24, wherein step a) comprises dispersing metallic silver, lithium, or barium in a solvent and adding a transition metal oxide to said dispersion.

31. The process according to claim 24, wherein step b) comprises aging said dispersion for a period of at least about 3 days.

32. The process according to claim 31, wherein step b) comprising aging said dispersion for a period of about 7 to about 14 days.

33. The process according to claim 24, wherein step c) comprises one or more steps selected from the group consisting of:
i) drying under ambient conditions using oxygen, air, or an inert gas;
ii) vacuum drying using a rotary evaporator or vacuum line;
iii) freeze drying by cooling said gel below the freezing temperature of said solvent and applying a vacuum thereto to remove said solvent;
iv) heating said gel to a supercritical temperature and pressure of said solvent;
v) treating said gel with supercritical carbon dioxide under ambient temperature conditions;
vi) vacuum outgassing using a vacuum oven at a temperature between about 100-500° C. for a period of about 0.1 to about 10 hours; and
vii) exchanging said solvent with a second solvent and then removing said second solvent using any of steps i)-vi).

34. The process according to claim 24, wherein step d) comprises heating said residue to a temperature of between about 100 to about 1000° C. for a period of between about 30 minutes to about 50 hours.

35. The process according to claim 24, wherein said solvent is selected from the group consisting of water, organic solvents, and mixtures thereof.

36. The process according to claim 35, wherein said solvent comprises a member selected from the group consisting of ketones, alcohols, aliphatic hydrocarbons, cyclic hydrocarbons, aromatic hydrocarbons, water, and combinations thereof.

37. A battery comprising an electrode containing the mixed metal oxide material of claim 1.

38. A battery comprising an electrode containing the mixed metal oxide of claim 14.
